(19) United States
(12) Patent Application Publication
(10) Pub. No.: US 2006/0149426 A1
(43) Pub. Date: Jul. 6, 2006

(54) Detecting an eye of a user and determining location and blinking state of the user

(76) Inventors: Mark A. Unkrich, Redwood City, CA (US); Julie E. Fouquet, Portola Valley, CA (US); Richard E. Haven, Sunnyvale, CA (US); Daniel Usikov, Newark, CA (US); John Stewart Wenstrand, Menlo Park, CA (US); Todd Stephen Sachs, Palo Alto, CA (US); James G. Horner, Santa Clara, CA (US)

Correspondence Address: AVAGO TECHNOLOGIES, LTD., P.O. BOX 1920, DENVER, CO, 80201-1920, US

(21) Appl. No.: 11/028,151

(22) Filed: Jan. 4, 2005

(51) Int. Cl. G06F 17/00

(52) U.S. Cl. 701/1; 701/51; 701/45

(57) ABSTRACT

A method and apparatus for detecting a location of an eye of a user using an automated detection process, and automatically determining a position of a head of the user with respect to an object based on the detected location of the eye. A location of an eye of a user inside a vehicle is detected using the automated detection process, at least one of height and orientation information of the user is automatically determined based on the detected location of the eye, and a mechanical device inside the vehicle is controlled in accordance with the determined information. Moreover, an eye blinking pattern of a user is detected using an infrared reflectivity of an eye of the user, and messages are transmitted from the user in accordance with the detected eye blinking pattern of the user.

### BACKGROUND OF THE INVENTION

2. Description of the Related Art

Detection of the position of a vehicle occupant is very useful in various industries. One industry that uses such information is the automotive industry where the position of a vehicle occupant is detected with respect to an airbag deployment region to prevent an injury occurring when an airbag deploys due to an automobile crash or other incident. Generally, current solutions rely on a combination of sensors including seat sensors, which detect the pressure or weight of an occupant to determine whether the seat is occupied. However, because this system does not provide a distinction between tall and short occupants, for example, or occupants who are out of position during a collision, an injury may still result from the explosive impact of the airbag into out-of-position occupants. Further, the airbag may be erroneously deployed upon sudden deceleration when using the weight sensors to detect the position of the vehicle occupant.

Other solutions provide capacitive sensors in the roof of a vehicle to determine a position of the vehicle occupant. However, similar to the weight or pressure sensors, the capacitive sensors do not provide accurate positioning information of small occupants, such as children. The capacitive sensors also require a large area in the roof of the vehicle for implementation and are not easily capable of being implemented in existing vehicles.

### SUMMARY OF THE INVENTION

Various embodiments of the present invention provide a method including (a) detecting a location of an eye of a user using an automated detection process, and (b) automatically determining a position of a head of the user with respect to an object based on the detected location of the eye.

Various embodiments of the present invention provide a method including (a) detecting a location of an eye of a user using an automated detection process, and (b) automatically determining at least one of height and orientation information of the user with respect to an object based on the detected location of the eye.

Moreover, various embodiments of the present invention provide a method including (a) detecting a location of an eye of a user inside a vehicle using an infrared reflectivity of the eye or a differential angle illumination of the eye, (b) automatically determining at least one of height and orientation information of the user based on the detected location of the eye, and (c) controlling a mechanical device inside the vehicle in accordance with the determined information of the user.

Various embodiments of the present invention provide a method including (a) detecting a location of an eye of a user inside a vehicle using an infrared reflectivity of the eye or a differential angle illumination of the eye, (b) automatically determining a position of a head of the user based on the detected location of the eye, and (c) controlling a mechanical device inside the vehicle in accordance with the determined position of the head.

Various embodiments of the present invention provide a method including (a) detecting a location of an eye of a user using an automated detection process, (b) determining a position of the user based on the detected location of the eye, and (c) automatically implementing a pre-crash and/or a post-crash action in accordance with the determined position.

Various embodiments of the present invention further provide a method including (a) detecting an eye blinking pattern of a user using an infrared reflectivity of an eye of the user, and (b) transmitting messages from the user in accordance with the detected eye blinking pattern of the user.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a process of detecting a location of an eye using an automated detection process and automatically determining a position of a head with respect to an object based on the detected location of the eye, according to an embodiment of the present invention.

FIG. 2 is a diagram illustrating a process of detecting a location of an eye using an automated detection process and automatically determining at least one of height and orientation information based on the detected location of the eye, according to an embodiment of the present invention.

FIG. 3 is a diagram illustrating a process for detecting a location of an eye using an automated detection process and automatically determining a position of a head of the user with respect to an object based on the detected location of the eye, according to an embodiment of the present invention.

FIG. 4 is a diagram illustrating an apparatus for detecting a location of an eye using an automated detection process, and automatically determining at least one of height and orientation information of a user with respect to an object based on the detected location of the eye, according to an embodiment of the present invention.

FIGS. 5A and 5B are diagrams illustrating a process of detecting a location of an eye of a user inside a vehicle, according to an embodiment of the present invention.

FIGS. 6A, 6B and 6C are diagrams illustrating a process of detecting locations of eyes of a user inside a vehicle, according to an embodiment of the present invention.

FIG. 7 is a diagram illustrating a process of detecting a location of an eye using an automated detection process, determining a position of a user based on the detected location of the eye and automatically implementing a pre-crash and/or post-crash action in accordance with the determined position, according to an embodiment of the present invention.

FIG. 8 is a diagram illustrating a process of detecting an eye blinking pattern using an infrared reflectivity of an eye and transmitting messages from a user in accordance with the detected eye blinking pattern, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

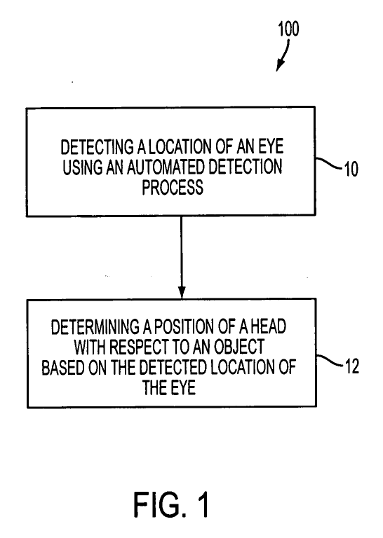

FIG. 1 is a diagram illustrating a process 100 for detecting a location of an eye using an automated detection process and automatically determining a position of a head with respect to an object based on the detected location of the eye, according to an embodiment of the present invention. Referring to FIG. 1, in operation 10, a location of an eye of a user is detected using an automated detection process. While operation 10 refers to an eye of a user, the present invention is not limited to detecting a single eye of the user. For example, locations of both eyes of a user can be detected using an automated detection process.

The term “automated” indicates that the detection process is performed in an automated manner by a machine, as opposed to detection by humans. The machine might include, for example, a computer processor and sensors. Similarly, various processes may be described herein as being performed “automatically”, thereby indicating that the processes are performed in an automated manner by a machine, as opposed to performance by humans.

The automated detection process to detect the location of an eye(s) could be, for example, a differential angle illumination process such as that disclosed in U.S. application Ser. No. 10/377,687, U.S. patent Publication No. 20040170304, entitled “APPARATUS AND METHOD FOR DETECTING PUPILS”, filed on Feb. 28, 2003, by inventors Richard E. Haven, David J. Anvar, Julie E. Fouquet and John S. Wenstrand, attorney docket number 10030010-1, which is incorporated herein by reference. In this differential angle illumination process, generally, the locations of eyes are detected by detecting pupils based on a difference between reflected lights of different angles of illumination. More specifically, lights are emitted at different angles and the pupils are detected using the difference between reflected lights as a result of the different angles of illumination. Moreover, in this process, two images of an eye that are separated in time or by wavelength of light may be captured and differentiated by a sensor(s) to detect a location of the eye based on a difference resulting between the two images.

Alternatively, the automated detection process to detect the location of an eye(s) could be, for example, a process such as that disclosed in U.S. application Ser. No. 10/843,517, entitled “METHOD AND SYSTEM FOR WAVELENGTH-DEPENDENT IMAGING AND DETECTION USING A HYBRID FILTER”, filed on May 10, 2004, by inventors Julie E. Fouquet, Richard E. Haven, and Scott W. Corzine, attorney docket number 10040052-1, and U.S. application Ser. No. 10/739,831, entitled “METHOD AND SYSTEM FOR WAVELENGTH-DEPENDENT IMAGING AND DETECTION USING A HYBRID FILTER”, filed on Dec. 18, 2003, attorney docket number 10031131-1, which are incorporated herein by reference. In this process, generally, at least two images of a face and/or eyes of a subject are taken, where one image is taken, for example, at or on an axis of a detector and the other images is taken, for example, at a larger angle away from the axis of the detector. Accordingly, when eyes of the subject are open, the difference between the two images highlights the pupils of the eyes, which can be used to infer that the subject's eyes are closed when the pupils are not detectable in the differential image.

Further, as described in the above-referenced U.S. applications titled “METHOD AND SYSTEM FOR WAVELENGTH-DEPENDENT IMAGING AND DETECTION USING A HYBRID FILTER”, a wavelength-dependent illumination process can be implemented in which, generally, a hybrid filter having filter layers is provided for passing a light at or near a first wavelength and at or near a second wavelength while blocking all other wavelengths for detecting amounts of light received at or near the first and second wavelengths. Accordingly, generally, a wavelength-dependent imaging process is implemented to detect whether the subject's eyes are closed or open.

The general descriptions herein of the above-described automated detection processes are only intended as general descriptions. The present invention is not limited to the general descriptions of these automated detection processes. Moreover, the above-referenced automated detection processes are only intended as examples of automated detection processes to detect the location of an eye(s). The present invention is not limited to any particular process.

Referring to FIG. 1, from operation 10, the process 100 moves to operation 12, where a position of a head of a user with respect to an object is determined based on the detected location of at least one eye in operation 10. There are many different manners of determining the position of a head with respect to an object in operation 12, and the present invention is not limited to any particular manner.

For example, in operation 12 of FIG. 1, a position of a head of the user with respect to an object can be determined using a triangulation method in accordance with the detection results in operation 10, according to an embodiment of the present invention. For example, a triangulation method using stereo eye detection systems can be implemented to generate information indicating a three-dimensional position of the head by applying stereoscopic imaging in addition to the detection of operation 10.

More specifically, as an example, with stereo eye detection systems, each eye detection system would provide eye location information in operation 10. Then, in operation 12, a triangulation method would be used between the eye detection systems to provide more detailed three-dimensional head position information. In addition, the triangulation method could be implemented in operation 12 to provide, for example, gaze angle information.

To improve accuracy, timing of imaging between the stereo eye detection systems could be well controlled. There are a number of manners to accomplish such control. For example, such control can be accomplished by using a buffer memory in each eye detection system to temporarily store images taken simultaneously by the eye detection systems. The memory of a respective eye detection system might be, for example, a separate memory storage block downloaded, for example, from a pixel sensor array of the respective eye detection system. Alternatively, image data may be temporarily stored, for example, in the pixel array itself. The images from the different eye detection systems could then, for example, be sequentially processed to extract eye location information from each image.

As another example of the use of stereo eye detection systems, the cost of a buffer memory or pixel complexity may be reduced, for example, by eliminating the memory component. For example, eye detection systems could include, for example, CMOS image sensors which are continuously recording sequential images. The readout of each image sensor can then be scanned on a line-by-line basis. Effectively, simultaneous images may be extracted by reading a line from a first sensor and then reading the same line from a second sensor. The readout from the two images can then be interleaved. Subsequent lines could be alternatively read out from alternating image sensors. Information on the eye location can then be extracted from each of the composite images made up of the alternate lines of the image data as it is read, to thereby provide information indicating a three-dimensional position of the head.

The above-described examples of the operation of stereo eye detection systems are only intended as examples. The present invention is not limited to any particular manner of operating stereo eye detection systems.

Instead of using a triangulation method, in operation 12, an algorithm can be used to determine the position of a head of the user with respect to an object based on the detected location of at least one eye in operation 10. An example of an algorithm might be, for example, to estimate a boundary of a head by incorporating average distances of facial structures from a detected location of an eye. Since the location of the object is known, the position of the head with respect to the object can be determined from the estimated boundary of the head. Of course, this is only an example of an algorithm, and the present invention is not limited to any particular algorithm.

Further, as an additional example, in operation 12 of FIG. 1, a position of the head of the user with respect to an object can be determined using an interocular distance between eyes of the user. For example, the position of the object is known. For example, the object might be, for example, an airbag, a dashboard or a sensor. Therefore, as the determined interocular distance becomes wider, it can be inferred that the position of the head is closer to the object. Of course, this is only an example of the use of an interocular distance to determine the position of the head with respect to the object, and the present invention is not limited to this particular use of the interocular distance.

Therefore, in operation 12 of FIG. 1, the position of the head is determined with respect to an object based on the detected location of at least one eye. For example, according to an embodiment of the present invention, when a user is located inside a vehicle, the location of at least one eye of the user is detected and a position of the head of the user with respect to an object is determined based on the detected location of the eye.

In various embodiments of the present invention, as will be discussed in more detail further below, a mechanical device of the vehicle can be appropriately controlled, or appropriate corrective action can be taken, in accordance with the determined position of the head of a user, or simply in accordance with a determined position of the user.

For example, the object in the vehicle might be a dashboard, so that the position of the head with respect to the dashboard is determined. Then, a mechanical device of the vehicle can be controlled based on the determined position. For example, in various embodiments of the present invention, appropriate control can be automatically performed to adjust a seat or a mirror (such as, for example, a rear view mirror or a side view mirror). Of course, the present invention is not limited to the object being the dashboard, or to the controlled mechanical device being a seat or a mirror.

Alternatively, in various embodiments of the present invention, appropriate control can be automatically performed to implement a pre-crash corrective action. Such pre-crash corrective action could include, for example, activating a seat belt, performing appropriate braking action, performing appropriate speed control, performing appropriate vehicle stability control, etc. These are only intended as examples of pre-crash corrective action, and the present invention is not limited to these examples.

In addition, in various embodiments of the present invention, appropriate control can be automatically performed to implement a post-crash corrective action. Such post-crash corrective action could include, for example, automatically telephoning for assistance, automatically shutting off the engine, etc. These are only intended as examples of post-crash crash corrective actions, and the present invention is not limited to these examples.

Therefore, it should be understood that “pre-crash” corrective actions are actions that are taken before the impending occurrence of an expected event, such as a crash. “Post-crash” corrective actions are actions that are taken after the occurrence of the expected event, such as a crash. However, it should be understood that an expected event might not actually occur. For example, pre-crash actions might be automatically implemented which prevent the crash from actually occurring.

While determining a position of a head of the user with respect to an object is described in relation to a user inside a vehicle, the present invention is not limited to determining a position of a head of the user in a vehicle. For example, the present invention can be implemented to detect the location of an eye of the user with respect to the vehicle itself for keyless entry into the vehicle.

Accordingly, in process 100, a location of an eye of a user is detected using an automated detection process and a position of a head of the user with respect to an object is determined based on the detected location of the eye. The determined position of the head enables use of the determined position of the head in various applications.

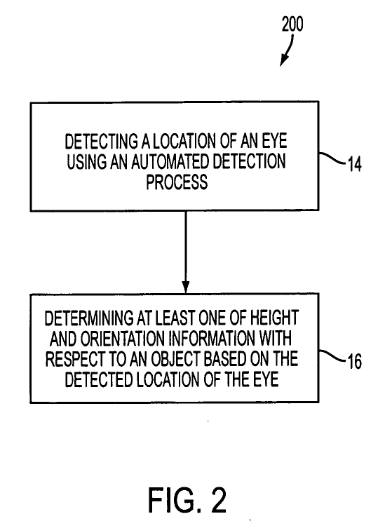

FIG. 2 is a diagram illustrating a process 200 of detecting a location of an eye of a user using an automated detection process and automatically determining at least one of height and orientation information of the user with respect to an object based on the detected location of the eye, according to an embodiment of the present invention. Referring to FIG. 2, in operation 14, a location of an eye is detected using an automated detection process. For example, the various previously-described automated detection processes can be used to detect the location of an eye. However, the present invention is not limited to any specific automated process of detecting a location of an eye.

From operation 14, the process 200 moves to operation 16, where at least height and orientation information of the user is determined with respect to an object based on the detected location of the eye. For example, assuming a user is seated upright in a car seat, the position of the eye in a vertical dimension corresponds directly to the height of the user. However, when the user is near the object, the height calculated from the location of the eye(s) in a vertical dimension could be misleading. Thus, in an embodiment of the present invention, in a case where the user is too near to the object, an interocular distance between the eyes of the user, which corresponds to the distance to the user, can be correlated to a certain distance where a wider interocular distance generally corresponds to the user being close and a relatively narrow interocular distance indicates vice versa.

Further, when the user's head is rotated right or left, the interocular distance between the eyes may indicate a closer eye spacing with respect to the object. Accordingly, additional characterization may be implemented to determine head rotation, according to an embodiment of the present invention. For example, feature extraction of a nose of the user relative to the eyes can be used to distinguish between closer eye spacing due to head rotation and due to decreasing distance between the head and the object.

As an additional example, sensors may be provided to detect the location of the eyes of the user and the height and orientation information can be determined using a triangulation method in accordance with detection results of the sensors.

However, the present invention is not limited to any specific manner of determining height and orientation information of a user.

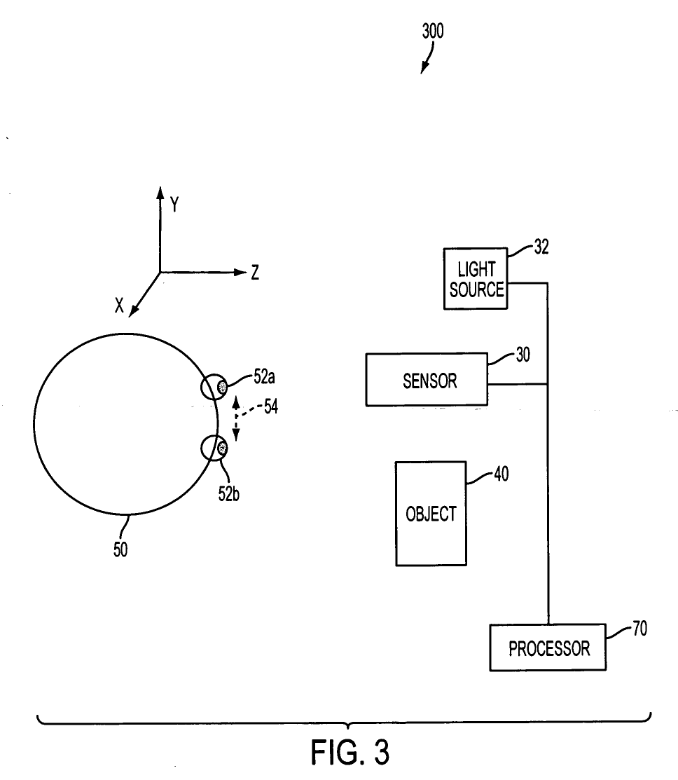

FIG. 3 is a diagram illustrating a process 300 for detecting locations of eyes of a user and automatically determining a position of a head of a user with respect to an object based on the detected location of the eyes, according to an embodiment of the present invention. As shown in FIG. 3, a sensor 30 is provided to detect a location of eyes 52a and 52b of a user. While only one sensor 30 is used to illustrate the process 300, more than one sensor 30 may be provided to detect the location of eyes 52a and 52b of the user. For example, as mentioned above, multiple sensors may be provided to detect the location of eyes 52a and 52b of the user using a triangulation method.

Further, FIG. 3 illustrates an interocular distance 54 between the eyes 52a and 52b for detecting respective locations of the eyes 52a and 52b and determining a position of a head 50 with respect to an object 40 in accordance with the interocular distance 54 between the eyes 52a and 52b of the user. While FIG. 3 is described using one object 40, the present invention can be implemented to determine a position of the head 50 with respect to more than one object 40. For example, the present invention can be implemented to determine the position of the head 50 with respect to a steering wheel and a mirror inside a vehicle.

Referring to FIG. 3, a light source 32 is provided for illuminating the eyes 52a and 52b to execute an automated detection process for detecting the location of the eyes 52a and 52b. The light source can be implemented using, for example, light emitting diodes (LEDs) or any other appropriate light source. However, the present invention is not limited to any specific type or number of light sources.

As also shown in FIG. 3, a processor 70 is connected with the sensor 30 and the light source 32 to implement the automated detection process. The present invention, however, is not limited to providing the processor 70 connected with the sensor 30 and the light source 32. For example, the processor 70 may be provided to the sensor 30 to execute the detection process. Further, the present invention is not limited to any specific type of processor.

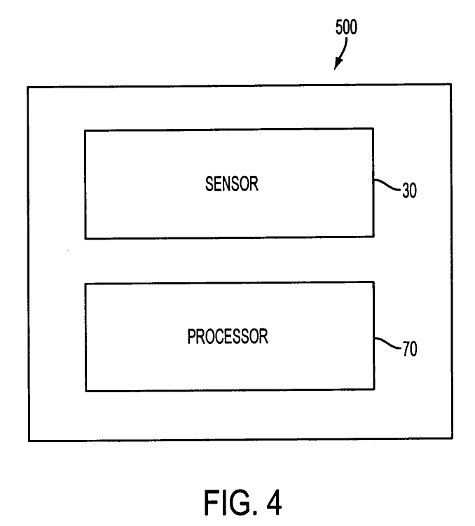

FIG. 4 a diagram illustrating an apparatus 500 for detecting a location of an eye of a user using an automated detection process, and automatically determining at least height and orientation information of the user with respect to an object based on the detected location of the eye, according to an embodiment of the present invention. As shown in FIG. 4, the apparatus includes a sensor 30 and a processor 70. The sensor 30 detects a location of an eye using an automated detection process, and the processor 70 determines height and orientation information of the user with respect to an object based on the detected location of the eye. While apparatus 500 is described using a sensor 30 and a processor 70, the present invention is not limited to a single processor and/or a single sensor. For example, in an embodiment of the present invention, the apparatus 500 could include at least two sensors for detecting a location of eyes of a user using a triangulation method.

Accordingly, the present invention provides an accurate method and apparatus for eye and position detection of a user.

Further, in various embodiments of the present invention, the position of the head of the user is determined in a three-dimensional space. For example, as shown in FIG. 3, a head 50, eyes 52a and 52b and an object 40 may exist in an x-y-z space, with the head 50 and the eyes 52a and 52b in an x-y plane and the object 50 in a z-axis perpendicular to the x-y plane. Accordingly, the present invention determines the position of the head 50 in the x-y plane in accordance with detected location of the eyes 52a and 52b in the x-y plane to determine the position of the head 50 with respect to the object 40 in the z-axis.

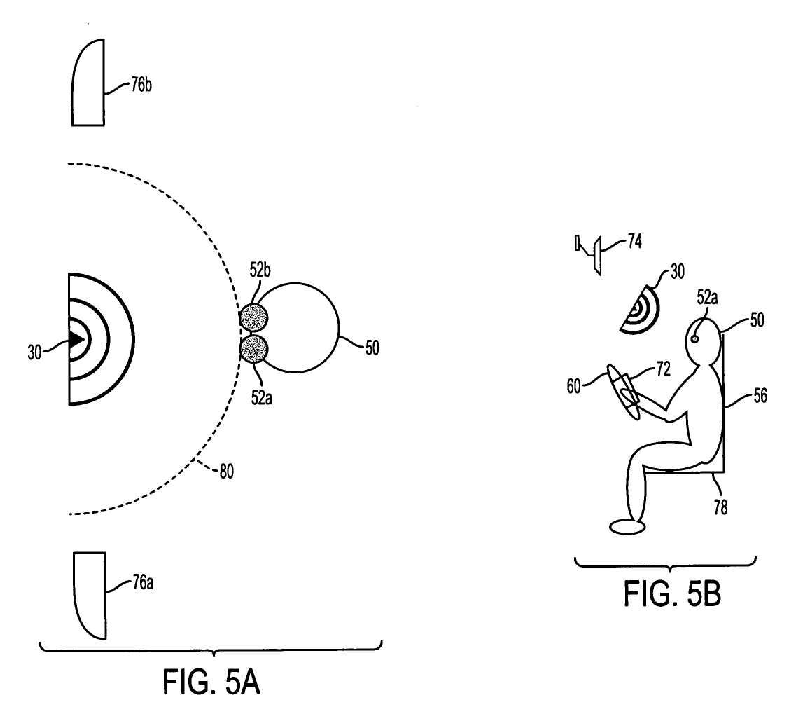

FIGS. 5A and 5B are diagrams illustrating a process of detecting a location of an eye of a user inside a vehicle using an automated detection process, according to an embodiment of the present invention. FIG. 5A illustrates a top view of the head 50 and the eyes 52a and 52b and FIG. 5B illustrates a side view of a user 56 in the vehicle. FIG. 5A also shows side view mirrors 76a and 76b of the vehicle. Accordingly, locations of the eyes 52a and 52b are detected using an automated detection process and a position of the head 50 is determined based on the detected location of the eyes 52a and 52b. For example, a sensor 30 having a field of view 80 can be provided to detect the location of the eyes 52a and 52b. The detection of the locations of the eyes 52a and 52b can be implemented using various automated detection processes, such as those mentioned above. For example, the locations of the eyes 52a and 52b can be detected by illuminating the eyes 52a and 52b from different angles and detecting the location of the eyes 52a and 52b based on reflections of the eyes 52a and 52b in response to the illumination. However, the present invention is not limited to any specific method of detecting a location of an eye(s).

FIG. 5B shows a side view of the user 56 sitting in a front seat 78 of a vehicle. As shown in FIG. 5B, the user 56 is seated in front of a steering wheel 60 of the vehicle having an air bag 72 installed therein and a rear view mirror 74. A location of the eye 52a of the user 56 inside the vehicle is detected, for example, using an infrared reflectivity of the eye 52a or a differential angle illumination of the eye 52a. Then, at least one of height and orientation information of the user 56 is determined based on the detected location of the eye 52a. As discussed previously, the determined height and orientation information can be implemented for various purposes. For example, the air bag 72, the rear view mirror 74, the steering wheel 60 and/or the front seat 78 of the vehicle can be controlled based on the determined height and orientation information of the user 56 with respect to the sensor 30 or with respect to the rear view mirror 74. In other embodiments of the present invention, an appropriate pre-crash and/or post-crash corrective action can be taken in accordance with the determined height and orientation information.

While FIG. 5B is described using an airbag 72 located in front of the user 56, the present invention is not limited to an airbag of a vehicle located in front of a user. For example, the present invention can be implemented to control a side airbag of a vehicle in accordance with determined height and orientation information of a user. In addition, the present invention is not limited to a mirror being a rear view mirror. For example, the height and orientation information of the user 56 can be determined with respect to a safety mirror such as those provided to monitor or view a child occupant seated in a back seat of a vehicle.

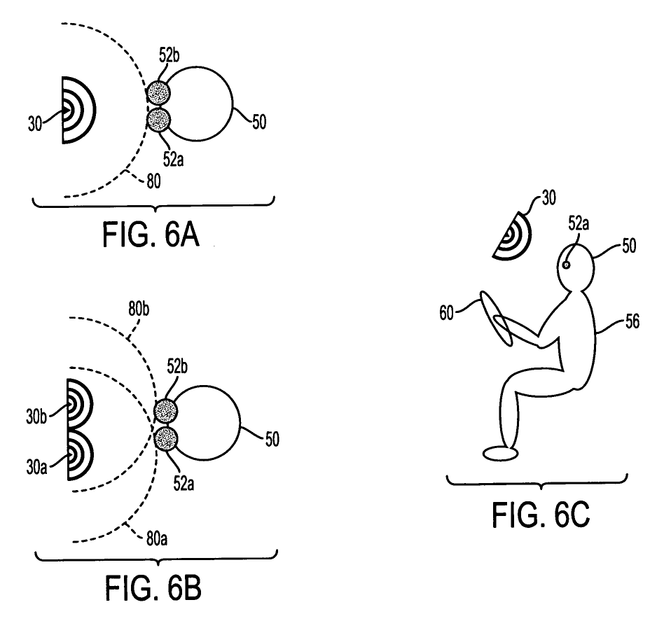

FIGS. 6A, 6B and 6C are diagrams illustrating a process of detecting locations of eyes of a user inside a vehicle using an automated detection process, according to an embodiment of the present invention. FIG. 6A illustrates detection of the locations of the eyes 52a and 52b in a two-dimensional field using a sensor 30 having a field of view 80, FIG. 6B illustrates detection of the location of the eyes 52a and 52b in a three-dimensional field using sensors 30a and 30b having respective field of views 80a and 80b and FIG. 6C illustrates a side view of a user 56 seated in a front seat of a vehicle. As shown in FIG. 6B, sensors 30a and 30b are provided to detect the locations of the eyes 52a and 52b using an automated detection process to determine at least height and orientation information of the user 56. As discussed above, for example, the locations of the eyes 52a and 52b can be detected by illuminating the eyes 52a and 52b from at least two angles and detecting the location of the eyes 52a and 52b using a difference between reflections responsive to the illumination. Then, the height and orientation of the user 56 is determined, for example, in accordance with an interocular distance between the eyes 52a and 52b based on the detected locations of the eyes 52a and 52b.

The determination of a position of a user based on detected location(s) of an eye(s) of the user enables various applications of the position information of the user. For example, various mechanical devices, such as seats, mirrors and airbags can be adjusted in accordance with the determined position of the user.

Moreover, for example, pre-crash corrective actions can be automatically performed to implement the pre-crash corrective actions based on the determined position of a user. Such pre-crash corrective action could include, for example, activating a seat belt, performing appropriate braking action, performing appropriate speed control, performing appropriate vehicle stability control, etc. These are only intended as examples of pre-crash corrective action, and the present invention is not limited to these examples.

In addition, in various embodiments of the present invention, post-crash corrective actions can be automatically performed to implement the post-crash corrective actions based on the determined position of a user. Such post-crash corrective action could include, for example, automatically telephoning for assistance, automatically shutting off the engine, etc. These are only intended as examples of post-crash crash corrective action, and the present invention is not limited to these examples.

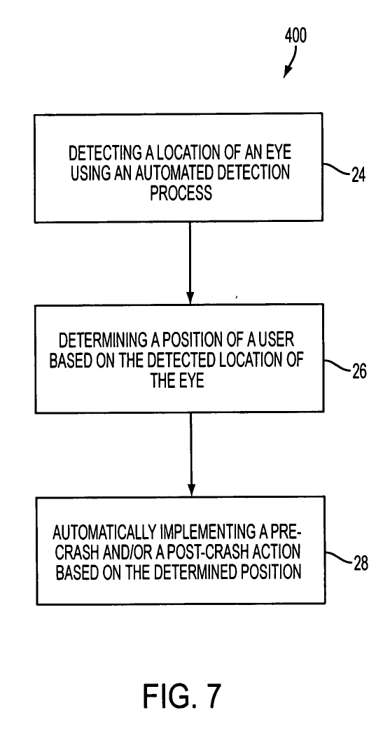

FIG. 7 is a diagram illustrating a process 400 of detecting a location of an eye using an automated detection process, determining a position of a user based on the detected location of the eye and automatically implementing a pre-crash and/or post-crash action in accordance with the determined position, according to an embodiment of the present invention. Referring to FIG. 7, in operation 24, a location of an eye is detected using an automated detection process. For example, the various automated detection processes described above can be used to detect the location of the eye.

Referring to FIG. 7, from operation 24, the process 400 moves to operation 26, where a position of a user is determined based on the detected location of the eye. For example, the position of the user can be estimated by correlating the detected location of the eye with height of the user to determine the position of the user.

From operation 26, process 400 of FIG. 7 moves to operation 28, where a pre-crash action and/or post-crash action is automatically implemented based on determined position of the user. However, the present invention is not limited to implementing a pre-crash and/or post-crash. For example, the impending event might be something other than a crash, and the automatically implemented action might be something other than pre-crash or post-crash corrective action.

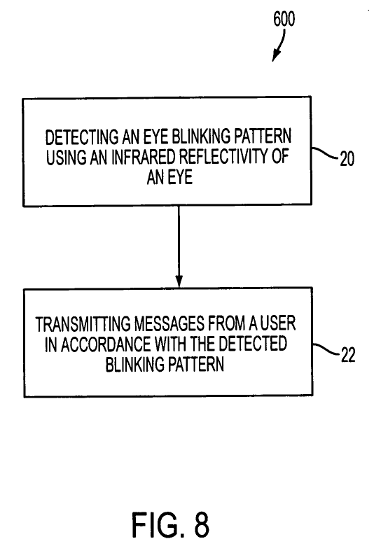

FIG. 8 is a diagram illustrating a process 600 of detecting an eye blinking pattern of a user using an infrared reflectivity of an eye of the user and transmitting messages from the user in accordance with the detected eye blinking pattern of the user, according to an embodiment of the present invention. Referring to FIG. 8, in operation 20, an eye blinking pattern is detected using an infrared reflectivity of the eye. Further, the automated detection process described in U.S. Application titled “APPARATUS AND METHOD FOR DETECTING PUPILS”, referenced above, can be used to detect an eye blinking pattern.

From operation 20, the process 600 moves to operation 22, where messages are transmitted from a user in accordance with the detected blinking pattern. For example, eye blinking pattern of a disabled person is automatically detected and the detected eye blinking pattern is decoded into letters and/or words of the English alphabet to transmit messages from the disabled person using the eye blinking pattern. Further, a frequency of the eye blinking pattern is used for transmitting messages from the user, according to an aspect of the present invention.

Referring to FIG. 8, the use of infrared reflectivity of an eye to detect the eye blinking pattern allows the eye blinking pattern of the user to be detected from multiple directions, without limiting the user to a confined portion of an area from which to transmit the messages. For example, a user may transmit messages within a wide area without being required to actively engage for the detection of the eye blinking pattern.

Therefore, the present invention also enables use of eye blinking pattern for communication purposes by detecting eye blinking pattern from multiple directions.

While various aspects of the present invention have been described using detection of eyes of a user, the present invention is not limited to detection of both eyes of the user. For example, an eye of a user can be detected and a position of a head of the user can be estimated using the detected eye of the user.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method, comprising:
detecting a location of an eye of a user using an automated detection process; and
automatically determining a position of a head of the user with respect to an object based on the detected location of the eye.

2. The method according to claim 1, wherein the automated detection process uses an infrared reflectivity of the eye to detect the location of the eye.

3. The method according to claim 1, wherein the automated detection process illuminates the eye from at least two angles and detects the location of the eye using a difference between reflections responsive to the illumination.

4. The method according to claim 1, wherein said detecting of the location of the eye comprises:
detecting the location of the eye by at least two sensors and using a triangulation method in accordance with detection results of said at least two sensors.

5. The method according to claim 1, wherein said determining of the position of the head comprises:
determining the position of the head in a three-dimensional space.

6. The method according to claim 1, wherein
the head includes two eyes,
the detecting of the location of the eye comprises detecting locations of the two eyes, respectively, and
the determining of the position of the head comprises determining the position of the head in accordance with an interocular distance between the two eyes.

7. The method according to claim 1, wherein the object is located inside a vehicle and the position of the head is determined with respect to the object in the vehicle.

8. The method according to claim 7, wherein the head, the eye and the object exist in an x-y-z space, with the head and the eye in an x-y plane and the object in a z-axis perpendicular to the x-y plane.

9. A method according to claim 1, further comprising:
automatically adjusting a mechanical device in a vehicle in accordance with the determined position.

10. A method according to claim 1, wherein the determined position indicates an impending crash, and the method further comprises:
automatically implementing pre-crash corrective action and/or post-crash corrective action in accordance with the determined position.

11. A method, comprising:
detecting a location of an eye of a user using an automated detection process; and
automatically determining at least one of height and orientation information of the user with respect to an object based on the detected location of the eye.

12. The method according to claim 11, wherein the automated detection process uses an infrared reflectivity of the eye to detect the location of the eye.

13. The method according to claim 11, wherein the automated detection process illuminates the eye from at least two angles and detects the location of the eye using a difference between reflections responsive to the illumination.

14. The method according to claim 11, wherein the object is located inside a vehicle and the at least one of height and orientation information of the user is determined with respect to the object in the vehicle.

15. The method according to claim 14, wherein the object inside the vehicle is a mechanical device of the vehicle, and the method further comprises:
controlling the mechanical device in accordance with the determined information.

16. The method according to claim 11, wherein the object is a mechanical device in a vehicle, and the method further comprises:
automatically controlling the mechanical device of the vehicle in accordance with the determined information.

17. The method according to claim 11, wherein the object is a mechanical device in a vehicle, and the method further comprises:
controlling another mechanical device in the vehicle in accordance with the determined information.

18. The method according to claim 11, wherein the object is an airbag in a vehicle, and the method further comprises:
controlling deployment of the airbag in accordance with the determined information.

19. The method according to claim 11, wherein the object is a side view mirror or a rear view mirror in a vehicle, and a position of the side view mirror or the rear view mirror is controlled in accordance with the determined information.

20. The method according to claim 11, wherein the object is a seat in a vehicle, and a position of the seat is controlled in accordance with the determined information.

21. The method according to claim 11, wherein the user has two eyes and said detecting of the location of the eye comprises detecting locations of the two eyes, respectively, in accordance with an interocular distance between the two eyes.

22. The method according to claim 21, wherein said detecting of the location of the two eyes comprises detecting the location of the two eyes in accordance with a database having information related to interocular distances between eyes of a plurality of users.

23. A method according to claim 11, wherein the user and the object are inside a vehicle, and the determined information indicates an impending crash of the vehicle, and the method further comprises:
automatically implementing a pre-crash and/or post-crash corrective action in accordance with the determined information.

24. A method, comprising:
detecting a location of an eye of a user inside a vehicle using an infrared reflectivity of the eye or a differential angle illumination of the eye;
automatically determining at least one of height and orientation information of the user based on the detected location of the eye; and
controlling a mechanical device inside the vehicle in accordance with the determined information.

25. The method according to claim 24, wherein the mechanical device is an airbag, a side view mirror, a rear view mirror, or a seat of the vehicle.

26. The method according to claim 24, wherein said detecting of the location of the eye comprises:
detecting the location of the eye by at least two sensors and using a triangulation method in accordance with detection results of said at least two sensors.

27. The method according to claim 24, wherein the user has two eyes and said detecting of the location of the eye comprises detecting locations of the two eyes, respectively, in accordance with an interocular distance between the two eyes.

28. A method, comprising:
detecting a location of an eye of a user inside a vehicle using an infrared reflectivity of the eye or a differential angle illumination of the eye;
automatically determining a position of a head of the user based on the detected location of the eye; and
controlling a mechanical device inside the vehicle in accordance with the determined position of the head.

29. The method according to claim 28, wherein the mechanical device is an airbag, a side view mirror, a rear view mirror, or a seat of the vehicle.

30. The method according to claim 28, wherein said detecting of the location of the eye comprises:
detecting the location of the eye by at least two sensors and using a triangulation method.

31. The method according to claim 28, wherein said determining of the position of the head comprises:
determining the position of the head in a three-dimensional space.

32. The method according to claim 28, wherein
the head includes two eyes,
the detecting of the location of the eye comprises detecting locations of the two eyes, respectively, and
the determining of the position of the head comprises determining the position of the head in accordance with an interocular distance between the two eyes.

33. The method according to claim 28, wherein said determining of the position of the head comprises:
extracting facial feature information of the user relative to the detected location of the eye and determining the position of the head in accordance with the extracted information.

34. A method, comprising:
detecting a location of an eye of a user using an automated detection process;
determining a position of the user based on the detected location of the eye; and
automatically implementing a pre-crash and/or a post-crash action in accordance with the determined position.

35. A method, comprising:
detecting an eye blinking pattern of a user using an infrared reflectivity of an eye of the user; and
transmitting messages from the user in accordance with the detected eye blinking pattern of the user.

36. The method according to claim 35, wherein the eye blinking pattern is detected from multiple directions.
